(19) United States
(12) Patent Application Publication
(10) Pub. No.: US 2015/0378642 A1
(43) Pub. Date: Dec. 31, 2015

(54) FILE SYSTEM BACK-UP FOR MULTIPLE STORAGE MEDIUM DEVICE

(71) Applicant: SEAGATE TECHNOLOGY LLC, (US)

(72) Inventors: John Edward Moon, Superior, CO (US); Stanton MacDonough Keeler, Longmont, CO (US); Margot Ann LaPanse, Superior, CO (US); Michael Edward Baum, Longmont, CO (US); Kai Bradley Gelatt, Longmont, CO (US); Nicolai Robert Ramler, Longmont, CO (US)

(73) Assignee: SEAGATE TECHNOLOGY LLC, Cupertino, CA (US)

(21) Appl. No.: 13/832,165

(22) Filed: Mar. 15, 2013

(51) Int. Cl. G06F 3/06

(52) U.S. Cl. CPC G06F 3/0679; G06F 3/065; G06F 3/0619

(57) ABSTRACT

A device may comprise a first data storage medium, a second data storage medium, and a controller. The controller may be configured to store file system information to the first data storage medium, storing a copy of file system information for the first data storage medium to the second data storage medium as a backup, loading the file system information from the first data storage medium to a cache memory when the file system information in the first data storage medium contains valid data, and loading the copy of the file system information from the second data storage medium to the cache when the file system information in the first data storage medium does not contain valid data.

### BACKGROUND

Data storage devices (DSDs) may comprise multiple data storage mediums. If file system information for a data storage medium was to become corrupted or the data storage medium was to fail, information about the availability of valid data may be lost. Therefore, systems and methods are needed for improving data storage device performance.

### SUMMARY

In one embodiment, a device may comprise a first data storage medium, a second data storage medium, and a controller. The controller may be configured to store a copy of file system information for the first data storage medium to the second data storage medium as a backup.

In another embodiment, a computer-readable storage medium may encode a computer program for executing on a computing system a computer process comprising storing file system information to a first nonvolatile memory, storing a copy of file system information for the first nonvolatile memory to a second nonvolatile memory as a backup, loading the file system information from the first nonvolatile memory to a cache memory when the file system information in the first nonvolatile memory contains valid data, and loading the copy of the file system information from the second nonvolatile memory to the cache when the file system information in the first nonvolatile memory does not contain valid data.

In yet another embodiment, a method may comprise storing file system information to a first nonvolatile memory, storing a copy of file system information for the first nonvolatile memory to a second nonvolatile memory as a backup, loading the file system information from the first nonvolatile memory to a cache memory when the file system information in the first nonvolatile memory contains valid data, and loading the copy of the file system information from the second nonvolatile memory to the cache when the file system information in the first nonvolatile memory does not contain valid data.

### BRIEF DESCRIPTION OF THE DRAWINGS

FIG. 1 is a diagram of an illustrative embodiment of a system of file system backup for a multiple storage medium device;

FIG. 2 is a diagram of an another illustrative embodiment of a system of file system backup for a multiple storage medium device;

FIG. 3 is a diagram of a an illustrative embodiment of a data storage device employing file system backup for a multiple storage medium device;

FIG. 4 is a flowchart of an illustrative embodiment of a method of employing file system backup for a multiple storage medium device; and

FIG. 5 is a flowchart of another illustrative embodiment of a method of employing file system backup for a multiple storage medium device.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

Some data storage devices can include multiple memories. For example, a hybrid hard drive may have a certain amount of non-volatile solid state memory (NVSSM), in addition to a rotating disc storage medium. The NVSSM may be any kind of nonvolatile solid state memory, such as NAND NVSSM, NOR NVSSM, NVRAM, or any solid state memory that may have its own file system. In some embodiments, a device may have two or more NVSSMs, of either different types or the same type, instead of or in addition to a disc memory. For the sake of clarity, the examples and embodiments described herein will refer to a device having a NVSSM and a disc memory; however, other configurations involving NVSSM will be apparent to one skilled in the art.

In an example embodiment, the data on the disc and the data in the NVSSM can occupy overlapping LBA (Logical Block Address) space. In such an embodiment, when there is a host request for data at a specific LBA it can either come from the disc or from the NVSSM, depending on which memory contains the latest valid data for that LBA and which memory provides a faster response. In some embodiments it is also possible to have data writes from the host sent directly to disc or to NVSSM. If the data is written directly to the NVSSM it can be mirrored to the disc in the background, in order to provide a back-up copy of the data. Such a backup may be made immediately, after a set amount of time, when the data storage device is idle, or based on other triggers.

File systems may be software employed on data storage devices to organize data, for example by keeping a log of what physical storage location in a memory contains data for a given LBA and what data is current and valid, and which data is old or invalid. In a system where data can be stored directly to a NVSSM memory and mirrored to a disc, a Non-Volatile File System (NVFS) may maintain a record of which data is valid (e.g. most recent) in the NVSSM, and what data has been mirrored to the disc. As used herein, a NVFS may be referred to as a file system or file system information.

In an example hybrid hard disc drive (HDD) that allows host data to be written directly to the NVSSM there may be a period of time in which the only valid data resides in the NVSSM. If, during this period, there is an event that causes corruption of the NVFS or the NVSSM becomes defective, then the hybrid HDD may not know for sure where the valid data is for any given LBA. The valid data could be in the NVSSM or it could be on the disc. This could result in sending the incorrect data back to the host on a read request or not be able to send data at all because it is unclear whether the data on disc is the most current version of the data.

In order to minimize the risk due to a loss of the file system, a backup copy can be stored to the disc memory. In an example hybrid HDD, a rotating disc can be used to store a copy of the NVFS such that if the copy that resides in NVSSM is destroyed or corrupted, the NVFS can still be retrieved from the disc and regenerated, thereby preventing sending invalid data to the host or not responding to a host request that could be properly serviced.

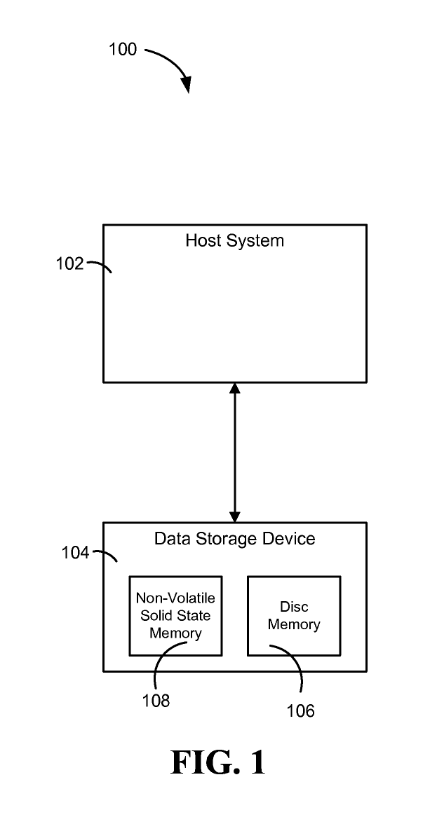

FIG. 1 depicts an embodiment of a system for file system backup for a multiple storage medium device, generally designated 100. The system 100 may include a host 102 and a data storage device (DSD) 104. The host 102 may also be referred to as the host system or host computer. The host 102 can be a desktop computer, a laptop computer, a server, a tablet computer, a telephone, a music player, another electronic device, or any combination thereof. Similarly, the DSD 104 may be any of the above-listed devices, or any other device which may be used to store or retrieve data. The host 102 and DSD 104 may be connected by way of a wired or wireless connection, or by a local area network (LAN) or wide area network (WAN). In some embodiments, the DSD 104 can be a stand-alone device not connected to a host 102, or the host 102 and DSD 104 may both be part of a single unit.

The DSD 104 can include one or more nonvolatile memories. In the depicted embodiment, the DSD 104 is a hybrid HDD including a rotating disc memory 106 and a NVSSM memory 108. In other embodiments, the DSD 104 may contain additional memories or memory types, including volatile and nonvolatile memories. In some embodiments, data on the disc and the data in the NVSSM occupy overlapping LBA space. For example, data stored in LBAs between 0 and 10,000 may be located in either the NVSSM memory or the disc memory. A NVFS may be used by the DSD 104 to keep track of what data is stored on the NVSSM, and whether that data is also backed up on the disc. In an embodiment where data has been stored to the NVSSM 108 and may be backed up to the disc 106, the NVFS may be used to determine whether data on the NVSSM 108 and disc 106 is a version of the most current, valid data for a given LBA.

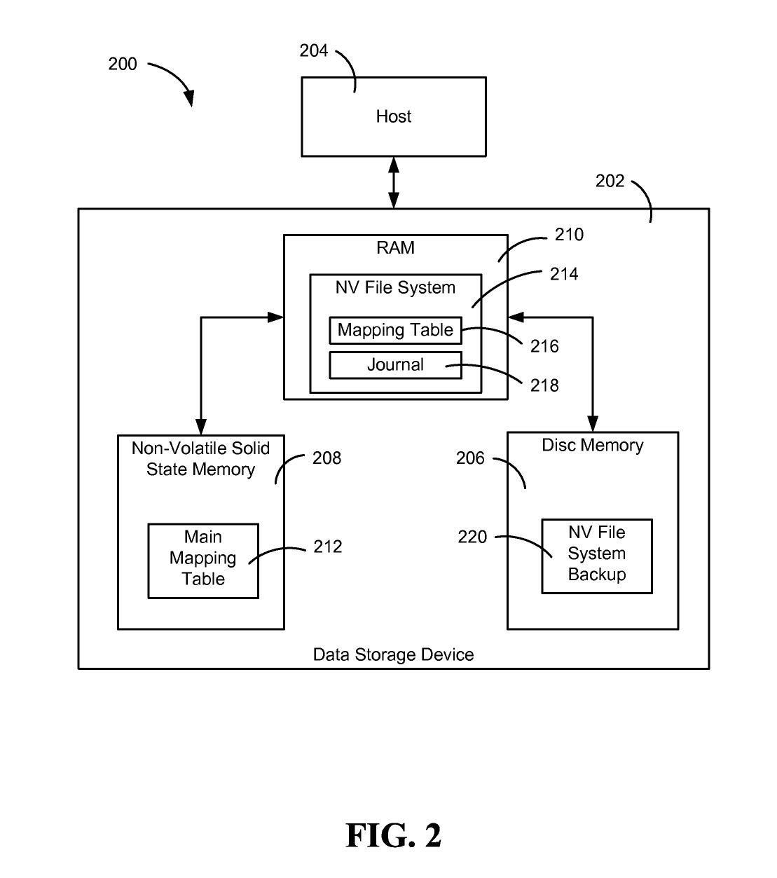

FIG. 2 depicts an embodiment of a system for file system backup for a multiple storage medium device, generally designated 200. The system 200 may include a data storage device 202 and a host device 204, which may correspond to the DSD 104 and host system 102 of FIG. 1. In the depicted embodiment, the DSD 202 may be a hybrid HDD including a disc memory 206, a NVSSM memory 208, and a RAM 210. In some embodiments, other non-volatile memory may be used in place of the disc 206 and NVSSM 208. The RAM 210 may act as a cache memory for the DSD 202, and may be any type of volatile memory such as DRAM or SRAM.

In an example embodiment, the NVFS may include a mapping table component and a journaling system component. The mapping table may include information on what information is stored in the NVSSM memory, in what physical storage locations, whether the data is current valid data, and whether it is backed up to disc memory. The journaling system may be a list of changes to data stored in the NVSSM memory based on write commands, erase commands, or other commands that may have changed the contents of the NVSSM since the last time the mapping table was updated. The journal can be used to update the mapping table to contain the most recent file system information.

In the embodiment depicted in FIG. 2, the main mapping table 212 may be stored in NVSSM memory 208. The main mapping table 212 may be loaded from the NVSSM memory 208 to the RAM 210, for example at a trigger event such as powering on the DSD 202. Keeping a copy of the NVFS 214 in the RAM 210 can provide faster access to the information during data operations. The NVFS 214 in RAM 210 can also include a journal 218 to track changes to the mapping table 216. During data operations, the file system 214 in RAM 210 can be updated with the journal 218 showing changes to the mapping table 216, such as newly stored data or data that has become invalid. The information in the journal 218 can be used to update the main mapping table 212 in the NVSSM at intervals. In some embodiments, the journal 218 can be stored to NVSSM 208 at intervals or based on triggers such as a controlled power-down event, and the mapping table 212 in NVSSM can be updated with information from one or more journals at larger intervals.

If there is an unexpected loss of power then the most current difference journal 218 in RAM 210 may be lost. On the next power-on the main mapping table 218 may be loaded into RAM 210, and the difference journal 218 may be recreated by searching through the contents of the NVSSM 208. For example, data stored to the NVSSM memory 208 may include meta-data pointing to the next valid data locations. Lost journal entries may be recovered by following the pointers to discover all unrecorded data changes. However, if the main mapping table 212 in NVSSM 208 is lost, it may be difficult or impossible to recreate it by analyzing the NVSSM memory.

To keep track of valid stored data in case of the loss of the mapping table 212 in NVSSM memory 208, a NV File System backup 220 may be saved to the disc memory 206. For example, after the main mapping table 212 is copied from the NVSSM 208 to the RAM 210, such as at a power-on event, it could also be copied to the disc 206. In addition, a copy of the mapping table 216 may be copied to the disc 206 every time the main mapping table 212 in the NVSSM 208 is updated with the journal 218. Whenever an update to the mapping table 212 or 216 using the journal 218 is triggered, the mapping table on the disc 220 could be updated as well. In some embodiments, the journal 218 may be copied to the NVSSM 208 and the disc 206 more frequently than the entire mapping table 216 is copied or updated. For example, anytime there is a controlled power down the journal 218 or the updated mapping table 216 can be copied from RAM 210 and written to the disc 206.

Making a backup of the NVFS 220 on the disc 206 can improve the reliability of the system 200 in several ways. If the main mapping table 212 in NVSSM 208 gets corrupted, it can be recreated by retrieving the backup 220 from the disc 206. This could save the time necessary to recreate recent changes to a mapping table by scanning the NVSSM 206, with increased reliability of accurate information. With no NVFS backup 220, the main mapping table 212 may be lost entirely due to corruption or NVSSM failure.

In addition, if the NVSSM 208 becomes completely inoperable then the DSD 202 can use the backup of the file system 220 on the disc 206 to determine how to respond to future read requests from the host 204. If the backup of the file system 220 indicates that the data on disc 206 for a given LBA is valid data, then the DSD 202 can respond with the valid data. For a given LBA, if the backup of the file system 220 indicates that the valid data was in the now defective NVSSM 208 and that the data in the corresponding disc LBA is invalid data, or no backup for the LBA was made to the disc 206, then the DSD 202 can respond to the host 204 with an Uncorrectable Data Error. This can prevent the DSD 202 from reporting erroneous data to the host 204.

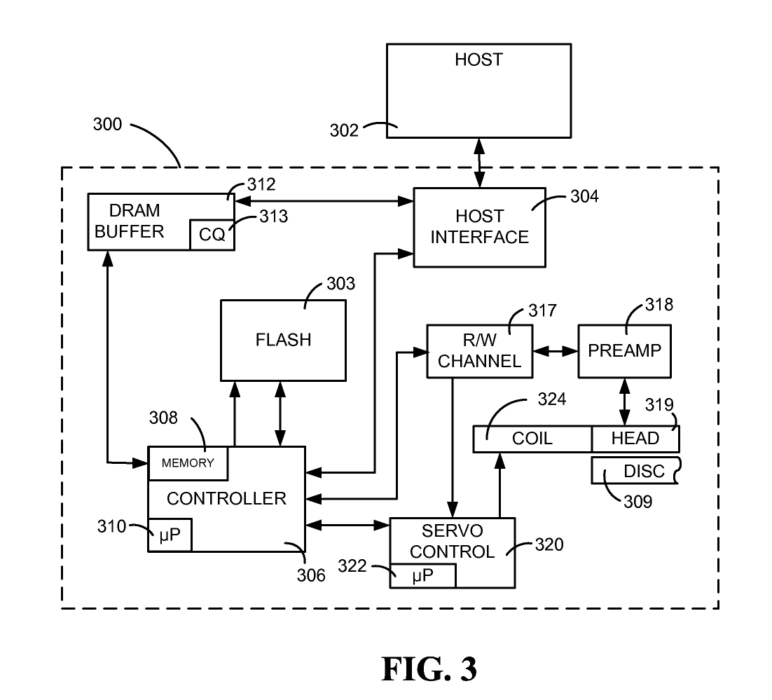

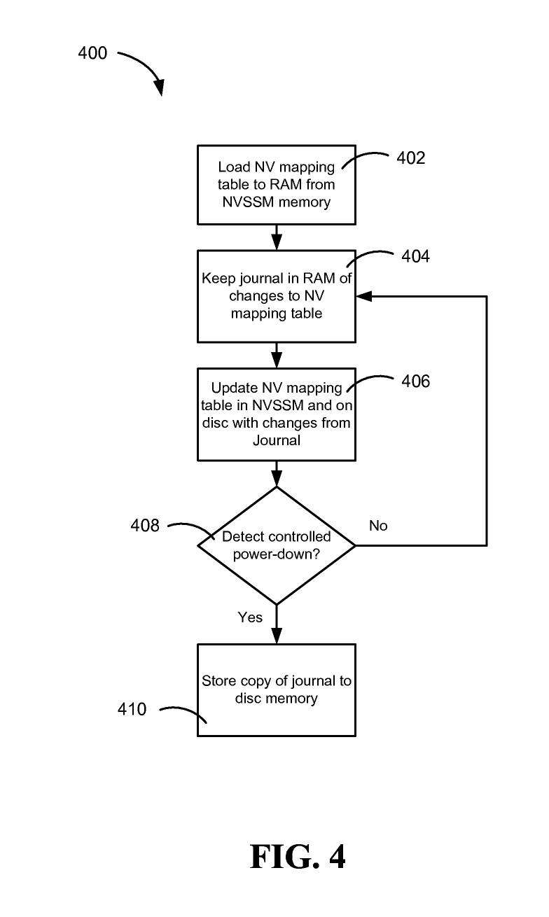

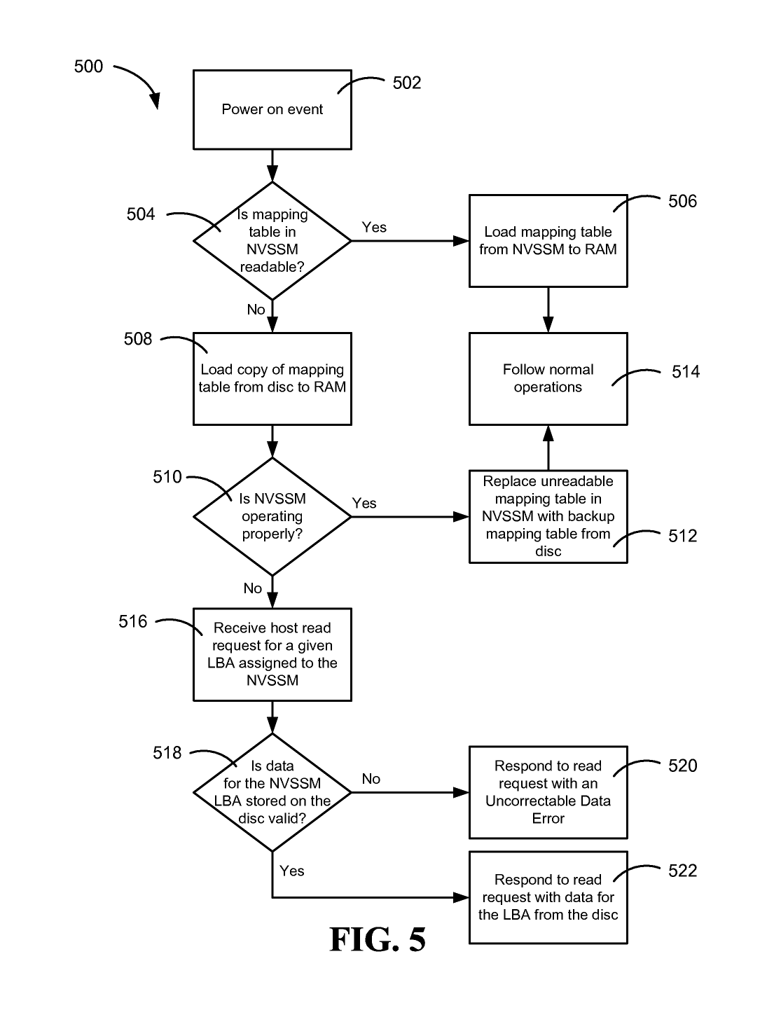

FIG. 3 is a diagram of another illustrative embodiment of a system utilizing file system backup for a multiple storage medium device, generally designated 300. Specifically, FIG. 3 provides a functional block diagram of a disc drive data storage device (DSD) 300. The DSD 300 may be a data storage device such as the device 104 shown in FIG. 1 or the DSD 202 shown in FIG. 2. The data storage device 300 can communicate with a host device 302 (such as the host system 102 shown in FIG. 1 or 204 shown in FIG. 2) via a hardware or firmware-based host interface circuit 304 that may include a connector (not shown) that allows the DSD 300 to be physically removed from the host 302. The buffer 312 can temporarily store user data during read and write operations and can include a command queue (CQ) 313 where multiple pending access operations can be temporarily stored pending execution. The DRAM buffer 312 may correspond to the RAM cache 210 from FIG. 2. A nonvolatile solid state memory 303, such as Flash memory, can be included for additional cache or buffer memory, or to provide additional addressable data storage for the DSD 300. The DSD 300 can include a programmable controller 306 with associated memory 308 and processor 310. The controller 306 or associated processor 310 may be configured to control the DSD 300 so as to implement a file system backup, such as the NVFS backup on a hybrid drive disclosed herein, and the steps of the methods depicted in FIGS. 4 and 5, disclosed below.

Further, FIG. 3 shows the DSD 300 can include a read/write (R/W) channel 317, which can encode data during write operations and reconstruct user data retrieved from disc(s) 309 during read operations. A preamplifier/driver circuit (preamp) 318 can apply write currents to the head(s) 319 and provides pre-amplification of readback signals. A servo control circuit 320 may use servo data to provide the appropriate current to the coil 324 to position the head(s) 319 over the disc(s) 309. The controller 306 can communicate with a processor 322 to move the head(s) 319 to the desired locations on the disc(s) 309 during execution of various pending commands in the command queue 313.

A NVFS mapping table may be stored in the NVSSM 303, and loaded to the DRAM buffer 312 during operation of the DSD 300. The DRAM buffer 312 may maintain a journal of changes to the mapping table corresponding to changes in data stored to the NVSSM 303, and may periodically update the mapping table in the NVSSM 303 based on the changes logged in the journal. For example, the mapping table in the NVSSM 303 may be updated at set time intervals, after a certain number of write commands to the NVSSM 303, when the DSD 300 is idle, when the journal becomes full, or based on other triggers.

In addition, the NVFS mapping table and journal may be copied from the NVSSM 303 or the DRAM buffer 312 to the disc 309 as a backup. The backup mapping table may be copied to the disc 309 or updated based on the journal whenever the mapping table in NVSSM 303 is updated, or based on other triggers, such as time, data writes, etc. In some embodiments, a copy or copies of the journal may be stored to the disc 309 in addition to or instead of the mapping table. For example, a copy of the journal may be stored to the disc 309 on a controlled power down of the DSD 300.

In the event that the main mapping table in the NVSSM 303 becomes corrupted or unreadable, the copy of the mapping table on the disc 309 can be used to restore the mapping table to the NVSSM 303 and to determine the status of data stored to the NVSSM 303 and disc 309. In the event that the NVSSM 303 becomes inoperable, the backup of the mapping table on the disc 309 can be used to determine how to respond to host read requests.

Turning now to FIG. 4, a flowchart of an illustrative embodiment of a method of employing file system backup for a multiple storage medium device is shown and generally designated 400. The depicted method could be used in a system such as the systems depicted in FIGS. 1, 2, and 3. The method 400 can involve loading a Non-Volatile (NV) mapping table from NVSSM to RAM, at 402. A journal of changes not reflected in the main mapping table may also be loaded from NVSSM to RAM. This operation may be invoked when a data storage device is powered on or a comreset signal is received from a host, for example.

During data operations to the NVSSM, a journal of changes to the NV mapping table may be kept in RAM in addition to a copy of the mapping table, at 404. The mapping table stored in the NVSSM may be updated with changes from the journal, and a copy of the mapping table may be stored to a disc memory, at 406. In some embodiments, a copy of the mapping table may be stored to disc when the mapping table is loaded into RAM, or soon after. The mapping tables in the NVSSM and disc may be updated with the information in the journal based on one or more triggers, such as after a set period of time, after a designated number of data writes, when the journal becomes full, or when the data storage device is idle. In some embodiments, an entire copy of the updated mapping table or journal is saved to the disc at intervals, and in other embodiments the copy of the mapping table stored to disc is updated with the journal information at intervals.

The method 400 may involve monitoring for a controlled power down event, at 408. When no controlled power down is detected, the method may continue keeping a journal of changes, at 404. If a controlled power down is detected, the method 400 may involve storing a copy of the journal from the RAM to the disc, at 410. This may involve simply storing a copy of the journal to disc, or updating a NV mapping table stored on the disc. In some embodiments, the mapping table in RAM may be updated with the journal, and the updated mapping table may be stored to disc. The journal may be used to update the main mapping table stored in NVSSM at a controlled power down event as well, or the journal itself may be stored to NVSSM.

Turning now to FIG. 5, a flowchart of another illustrative embodiment of a method of employing file system backup for a multiple storage medium device is shown and generally designated 500. The method may involve a power on event, at 502. This may involve applying power to a data storage device (DSD) including a plurality of nonvolatile memories. In one embodiment, the DSD may comprise a hybrid DSD including NVSSM and rotating disc memory.

The method 500 may include determining whether a mapping table of a NVFS stored in NVSSM is readable, at 504. In some embodiments, the determination of 504 may be of whether the NV file system stored in NVSSM should be used, wherein it should not be used if, e.g. it cannot be accessed due to memory failure, if the data is corrupt, if the data is outdated, if the data is invalid, or other factors which make the NVFS unreliable, unusable, or inaccurate. If the mapping table is properly readable, the method 500 may include loading the mapping table from the NVSSM to a RAM memory, at 506, and following normal DSD operations, at 514.

If the mapping table is not readable at 504, the method 500 may include loading a copy of the mapping table from disc memory to the RAM, at 508. A determination may be made as to whether the NVSSM is operating properly, at 510. This may involve performing diagnostics to determine whether data can be stored or retrieved from the NVSSM, or other diagnostic procedures. If the NVSSM is properly operational, the unreadable mapping table in the NVSSM can be replaced with the backup mapping table loaded from the disc, at 512. The DSD may resume normal operations, at 514.

If the NVSSM is not operating properly at 510, the method 500 may involve receiving a read request from a host device for a given LBA, at 516. In some embodiments, data for a given LBA may have been stored directly to the NVSSM, and a mirrored backup of the data may have been stored to the disc at some point. If the LBA points to the NVSSM, the NV mapping table may indicate whether a valid current copy of the data for the given LBA has been stored to the disc. If a read request for the given LBA is received, the DSD may be able to retrieve the data from the NVSSM if it is operating properly, or retrieve the data from the disc if it contains a current copy of the data.

After receiving the read request for a given LBA assigned to the NVSSM at 516, the method 500 may involve determining whether a valid copy of the data for the LBA is stored on the disc, at 518, since the NVSSM has been determined as not properly operating. If current valid data for the given LBA is not stored on the disc, the method 500 may involve responding to the read request with an uncorrectable data error, at 520. In some embodiments, a user may be given the option of retrieving non-current data for the LBA if such data is stored on disc, as this may allow recovery of an older version of the data instead of complete data loss.

If valid data for the given LBA is stored on the disc according to the backup mapping table, at 518, the method 500 may involve responding to the read request with the data for the LBA stored on the disc, at 522.

In accordance with various embodiments, the methods described herein may be implemented as one or more software programs running on a computer processor or controller. In accordance with another embodiment, the methods described herein may be implemented as one or more software programs running on a computing device, such as a personal computer that is using a disc drive. Dedicated hardware implementations including, but not limited to, application specific integrated circuits, programmable logic arrays, and other hardware devices can likewise be constructed to implement the methods described herein. Further, the methods described herein may be implemented as a computer readable medium including instructions that when executed cause a processor to perform the methods.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. A device comprising:
an interface adapted to allow the device to be physically connected to and disconnected from a host
a first data storage medium, including a non-volatile solid state memory storing a file system mapping table;
a second data storage medium, including another non-volatile memory; and
a third data storage medium, including a volatile solid-state memory;
a controller configured to:
load the file system mapping table to the volatile solid-state memory to allow the device to provide access to the file system mapping table during data operations;
store a copy of the file system mapping table to the disc memory as a backup;
maintain a journal in the volatile solid-state memory, the journal including information to track changes to the file system mapping table since the backup was created; and
copy the journal from the volatile solid-state memory to the another non-volatile memory when a power down is detected.

2. The device of claim 1, further comprising the non-volatile solid state memory includes flash memory.

3. The device of claim 2, further comprising the another non-volatile memory includes disc memory.

4. The device of claim 1, further comprising:
the controller further configured to:
determine if the file system mapping table in the non-volatile solid state memory should be used; and
when the file system mapping table in the non-volatile solid state memory should not be used, load the copy of the file system mapping table to the volatile solid-state memory from the another non-volatile memory.

5. The device of claim 4, further comprising:
the controller further configured to:
when the file system mapping table in the first data storage medium should not be used,
determine if the non-volatile solid state memory is operating properly; and
when the non-volatile solid state memory is operating properly,
replace the file system mapping table in the non-volatile solid state memory with the copy of the file system mapping table from the another non-volatile memory.

6. The device of claim 5, further comprising:
the controller further configured to:
receive a read request to load data from a specified logical block address (LBA) assigned to the non-volatile solid state memory;
when the non-volatile solid state memory is not operating properly,
determine if valid data for the specified LBA is stored on the another non-volatile memory based on the copy of the file system mapping table;
when valid data for the specified LBA is stored on the another non-volatile memory, respond to the read request with data from the another non-volatile memory; and
when valid data for the specified LBA is not stored on the another non-volatile memory, respond to the read request with an uncorrectable data error.

7. The device of claim 1, further comprising the file system mapping table information on what data is stored in the first data storage medium or the second data storage medium, and whether the data is current valid data.

8. The device of claim 1 further comprising:
the controller further configured to:
load the file system mapping table to the cache memory from the non-volatile solid state memory; and
update the file system mapping table in the non-volatile solid state memory with the changes from the journal and store a copy of the mapping table to the another non-volatile memory.

9. (canceled)

10. A device including a computer program for executing on a computing system a computer process comprising:
storing a file system mapping table to a first nonvolatile solid-state memory of a data storage device, the file system mapping table including a mapping of logical block addresses (LBAs) to physical storage locations of the data storage device;
storing a copy of the file system mapping table to a second nonvolatile memory of the data storage device as a backup, the second nonvolatile memory a different type of memory than the first nonvolatile solid-state memory;
storing a journal in a volatile solid-state memory of the data storage device, the journal including information to track changes to the file system mapping table since the backup was created;
loading the file system mapping tabled from the first nonvolatile solid-state memory to the volatile solid-state memory when the file system information in the first nonvolatile solid-state memory contains valid data; and
loading the copy of the file system mapping table from the second nonvolatile memory to the volatile solid-state memory when the file system mapping table in the first nonvolatile solid-state memory does not contain valid data.

11. The device of claim 10, the process further comprising:
determining if the first nonvolatile solid-state memory is operating properly when the file system mapping table in the first nonvolatile memory does not contain valid data; and
replacing the file system mapping table in the first nonvolatile solid-state memory with the copy of the file system mapping table from the second nonvolatile memory when the first nonvolatile solid-state memory is operating properly.

12. The device of claim 11, the process further comprising:
receiving a read request at the data storage device from a host, the read request including information to load data from a specified logical block address (LBA) assigned to the first nonvolatile solid-state memory;
when the first nonvolatile solid-state memory is not operating properly,
determining if valid data for the specified LBA is stored on the second nonvolatile memory based on the copy of the file system mapping table;
responding to the read request with data from the second nonvolatile memory when valid data for the specified LBA is stored on the second nonvolatile memory; and
responding to the read request with an uncorrectable data error when valid data for the specified LBA is not stored on the second nonvolatile memory.

13. The device of claim 10, the process further comprising:
the file system mapping table includes: information identifying whether data corresponding to an LBA mapping is current valid data.

14. The device of claim 10, the process further comprising:
updating the file system mapping table in the first nonvolatile solid-state memory with changes from the journal; and
storing a copy of the file system mapping table to the second nonvolatile memory after updating the file system mapping table.

15. The device of claim 10, the process further comprising:
copying the journal from the volatile solid-state memory to the second nonvolatile memory when a power down is detected.

16. A method comprising:
implementing a mapping table backup process for a removable data storage device having at least a first nonvolatile memory, a second nonvolatile memory of a different type of memory than the first nonvolatile memory, and a volatile cache memory, the mapping table backup process including:
storing a mapping table to a first nonvolatile memory, the mapping table including information identifying logical block address (LBA) to physical storage location mappings;
storing a copy of mapping table to a second nonvolatile memory as a backup;
loading the mapping table from the first nonvolatile memory to a volatile cache memory when the mapping table in the first nonvolatile memory contains valid data; and
loading the copy of the mapping table from the second nonvolatile memory to the cache when the mapping table in the first nonvolatile memory does not contain valid data.

17. The method of claim 16, further comprising the mapping table backup process including:
determining if the first nonvolatile memory is operating properly when the mapping table in the first nonvolatile memory does not contain valid data; and
replacing the mapping table in the first nonvolatile memory with the copy of the the mapping table backup process including from the second nonvolatile memory when the first nonvolatile memory is determined to be operating properly.

18. The method of claim 17, further comprising:
receiving a read request, at an interface of the removable data storage device, to load data from a specified logical block address (LBA) assigned to the first nonvolatile memory;
when the first nonvolatile memory is not operating properly,
determining if valid data for the specified LBA is stored on the second nonvolatile memory based on the copy of the mapping table;
responding to the read request with data from the second nonvolatile memory when valid data for the specified LBA is stored on the second nonvolatile memory; and
responding to the read request with an uncorrectable data error when valid data for the specified LBA is not stored on the second nonvolatile memory.

19. The method of claim 18, further comprising:
maintaining a journal, in the cache memory, to track changes to the mapping table;
periodically updating the mapping table in the first nonvolatile memory with the changes from the journal; and
storing a copy of the mapping table to the second nonvolatile memory after updating the mapping table.

20. The method of claim 19, further comprising:
when an unexpected loss of power occurs and the a most current journal in the cache memory is lost, recreating the most current journal including:
loading the mapping table in the cache memory;
searching through the contents of the first nonvolatile memory for meta-data pointers identifying next valid data locations; and
recovering lost journal entries by following the meta-data pointers to discover unrecorded data changes.
